(19) United States
(12) Patent Application Publication
(10) Pub. No.: US 2017/0337627 A1
(43) Pub. Date: Nov. 23, 2017

(54) INFORMATION DISTRIBUTION APPARATUS FOR SWITCHING STRUCTURE OF DATA FOR DIGITAL SCREEN DISPLAY, METHOD, AND NON-TRANSITORY COMPUTER READABLE STORAGE MEDIUM

(71) Applicant: YAHOO JAPAN CORPORATION, Tokyo (JP)

(72) Inventor: Tsutomu SANADA, Tokyo (JP)

(73) Assignee: YAHOO JAPAN CORPORATION, Tokyo (JP)

(21) Appl. No.: 15/441,877

(22) Filed: Feb. 24, 2017

(30) Foreign Application Priority Data
May 20, 2016 (JP) 2016-101644

(51) Int. Cl. G06Q 40/02

(52) U.S. Cl. CPC G06Q 40/025

(57) ABSTRACT

According to one aspect of an embodiment an information distribution apparatus includes an acquisition unit that, acquires a predetermined score stored in a storage device for a user corresponding to the client information terminal device; a selection unit that selects a data item to be incorporated as a. component into the data for digital screen display to be distributed to the client information terminal device in accordance with the score acauired by the acquisition unit; and a distribution unit that, after incorporating a component corresponding to the data selected by the selection unit into the data for digital screen display, distributes the resultant data for digital screen display to the client information terminal device that is a transmission source of the distribution request.

### CROSS-REFERENCE TO RELATED APPLICATIONS

The present application claims priority to and incorporates by reference the entire contents of Japanese Patent Application No. 2016-101644 filed in Japan on May 20, 2016.

### BACKGROUND OF THE INVENTION

### 1. Field of the Invention

The present invention relates to an information distribution apparatus for switching a structure of data for digital screen display, a method, and a non-transitory computer readable storage medium.

### 2. Description of the Related Art

Conventionally, technologies for accepting applications for services through smart devices such as smartphones and tablets are known. As an example of such technologies, a technology for accepting applications for various kinds of loans such as a card loan and a cashing loan through smart devices used by users is known. In an application for such a loan, information such as a name, date of birth, and the like of a user reguired for an application for the loan is accepted, and an examination is performed by a financial institution by using the input information.

Japanese Patent Application Laid-open No. 2009-123017

However, according to the conventional technology, there are cases where it takes time to input information accompanying an application for a service.

For example, according to the content of a service such as an application for various loans, there are many items of information to be input. However, in a portable device such as a smartphone, compared to a general personal computer (PC) or the like, the screen is small, and it is troublesome to input many items. For this reason, there are many users who give up applications for services in the middle of the process.

### SUMMARY OF THE INVENTION

It is an object of the present invention to at least partially solve the problems in the conventional technology.

According to one aspect of an embodiment an information distribution apparatus for switching a structure of data for digital screen display, the information distribution apparatus includes an acquisition unit that, through a digital communications network from a client communications network from a client information terminal device, in a case where a distribution request of data for digital screen display to accept an application by receiving a data transmission based on an input operation accepted is accepted in correspondence with a data item on a digital screen displayed by rendering in the client information terminal device, acquires a predetermined score stored in a storage device for a user corresponding to the client information terminal device. The information distribution apparatus for switching a structure of data for digital screen display, the information distribution apparatus includes a selection, unit that selects a data item to be incorporated as a component into the data for digital screen display to be distributed to the client information terminal device in accordance with the score acquired by the acquisition unit. The information distribution apparatus for switching a structure of data for digital screen display, the information distribution apparatus includes a distribution unit that, after incorporating a component corresponding to the data selected by the selection unit into the data for digital screen display, distributes the resultant data for digital screen display to the client information terminal device that is a transmission source of the distribution reauest.

The above and. other objects, features, advantages and technical and industrial significance of this invention will be better understood by reading the following detailed description of presently preferred embodiments of the invention, when considered in connection With the accompanying drawings.

### BRIEF DESCRIPTION OF THE DRAWINGS

FIG. 1 is a diagram that illustrates an example of an information distribution process performed by an information distribution apparatus according to an embodiment;

FIG. 2 is a diagram that illustrates an example of the configuration of an information distribution apparatus according to an embodiment;

FIG. 3 is a diagram that illustrates an example of information registered in. an item database according to an embodiment;

FIGS. 4A to 4C are diagrams that illustrate examples of items selected by an information distribution apparatus according to an embodiment;

FIG. 5 is a flowchart that illustrates an example of the flow of an information distribution process performed by an information distribution apparatus according to an embodiment; and

FIG. 6 is a diagram that illustrates an example of the hardware configuration.

### DETAILED DESCRIPTION OF THE PREFERRED EMBODIMENTS

Hereinafter, embodiments for performing an information distribution apparatus for switching a structure of data for digital screen display, a method, and a non-transitory computer readable storage medium according to the present application (hereinafter, referred to as embodiments) will be described in detail with reference to the drawings. However, the information distribution apparatus for switching a structure of data for digital screen display, the method, and the non-transitory computer readable storage medium according to the present application are not limited to these embodiments. In the embodiments described below, a same reference numeral is assigned to same parts, and duplicate description thereof will not be presented.

### Embodiment

1-1. Example of Information Distribution Apparatus

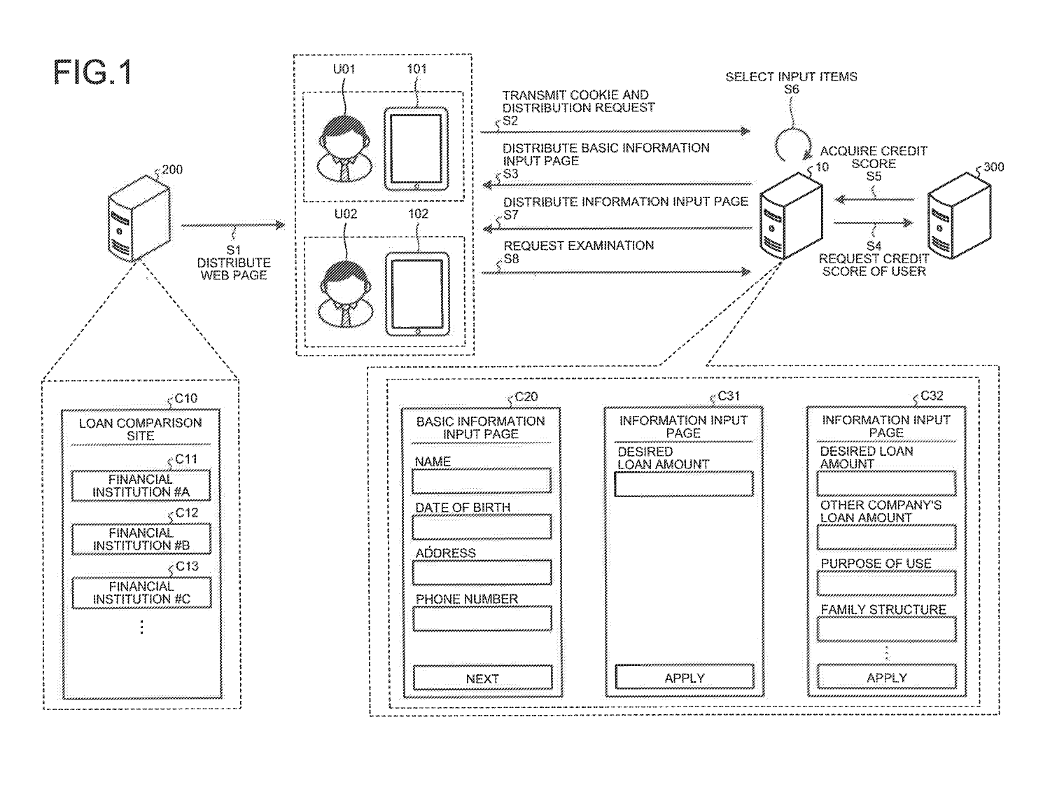

First, an example of an informatiOn distribution process performed by an information distribution apparatus will be described. FIG. 1 is a diagram that illustrates an example of an information distribution process performed by an information distribution apparatus according to an embodiment. An information distribution apparatus 10 can communicate with a user terminal 101 used by a user U01, a user terminal 102 used by a user U02, and a credit information providing server 300 through a predetermined. network N such as the Internet. Each of the user terminal 101 and the user terminal 102 (hereinafter, it may be collectively referred to as a “user terminal 100”) can communicate with a distribution server 200 through a predetermined network N such as the Internet.

The distribution server 200 is an information processing apparatus distributing a web content such as a web page and is realized by a server apparatus, a cloud system, or the like. For example, the distribution server 200 distributes a web page CIO relating to a loan comparison site comparing loans provided by a plurality of financial institutions. The distribution server 200 distributes the web page C10 in which an article comparing loans provided by financial institutions #A to #C and contents C11 to C13, in which links to loan application pages of the financial institutions #A to #C are set, are arranged. Here, the contents C11 to C13, usually, are contents such as texts, images, and the like in which links to sites of the financial institutions #A to #C are set and are advertisement contents for advertising the loans of the financial institutions #A to #C.

The user terminal 100 is a smart device such as a smartphone or a tablet and is a mobile terminal device capable of communicating with an arbitrary server apparatus through a radio communication network of 3rd generation (3G), long term evolution (LTE), or the like. In addition, the user terminal 100 may be not only the smart device but also an information processing apparatus such as a desktop PC or a notebook PC.

The credit information providing server 300 is an information processing apparatus that provides credit information used in a case where a financial institution performs an examination of a loan, a credit card, an installment payment, or the like (hereinafter, collectively referred to as “a loan or the like”) and is realized by a server apparatus, a cloud system, or the like. For example, the credit information providing server 300 is operated by a predetermined credit information organization and provides credit information of each of the users U01 and U02 in response to a request from the information distribution apparatus. More specifically, the credit information providing server 300 provides a score that is a credit score calculated based on credit information and evaluates the credits of the users U01 and U02.

Here, the credit information is information used as an indicator of user's credit when a credit transaction such as a loan is performed. For example, the credit information is information representing attribute information such as an individual annual income, house information, and a place of employment, various agreement contents relating to a credit transaction of a loan and the like, and objective transactions such as the status of payback, a balance, and the like and is called a credit history or a credit score, Such credit information is acquired by a financial institution from a credit information organization at the time of applying for a loan or the like, The financial institution determines whether or not a loan or the like is approved based on whether the credit information satisfies a predetermined condition. Particularly, in a case where a credit transaction such as a loan is permitted to a user, there are cases where an examination using credit information is essential.

The information distribution apparatus 10 is an information processing apparatus that distributes a web page used for accepting an application for a loan or the like to the user terminal 100 and is realized by a server apparatus, a cloud system, or the like. For example, in a case where the user U01 selects and clicks the content C11 among the contents C11 to C13 arranged on the web page C10, the information distribution apparatus 10 distributes a web page used for accepting an application for a loan or the like of the financial institution #A to the user terminal 101.

1-2. Information Distribution Process

Here, the information distribution apparatus 10 distributes a web page (hereinafter, also described as an “application page”) used for accepting the input of various kinds of information necessary for an examination of a loan or the like. For example, the information distribution apparatus 10 accepts information of items such as user's name, date of birth, address, telephone number, mail address, a desired loan amount that is an amount desired to be loaned, the other company loan. amount that has already been loaned by the user from the other companies, a payment period, occupation, title, position, the length of service, income, a family structure, the ages of family members, a monthly payment amount, and owner/no-owner of a car.

However, since it is troublesome for a user to input many items, there is concern that the user gives up the input in the middle of the process, and, as a result, a financial institution loses an opportunity of acquiring a customer. Particularly, in a case where the user uses a small device such as a smartphone, the amount of displayable information is smaller than that of a PC or the like, and it is difficult to perform input using a small keyboard, and. accordingly, there is a high possibility that an application is given up in the middle of the process.

Meanwhile, the items that are necessary for an examination. are changed in accordance with user's credit information. For example, for a user having a high payment capability and having no loaned money from the other companies, in other words, a user having high credit, a financial institution is predicted to be able to perform an examination by using predetermined essential items such as the name, the date of birth, and the like without using information such as the purpose of use, a monthly payment amount, and the like. On the other hand, for a user having a low credit level such as a user having a low payment capability, a user already having a large amount of loaned money, or the like, a financial institution is predicted to perform a detailed examination by using other items such as the purpose of use, a monthly payment amount, and the like in addition to the predetermined essential items.

However, at a time point at which a request for distributing an application page is received, a user applying for a loan or the like cannot be determined. For this reason, in a general application page, in accordance with a user having a low credit level, the input of many items is frequently requested.

Thus, the information distribution apparatus 10 performs an information distribution process as below. First, when a request for distributing a web page used for accepting an application for a service is received from a user, the information distribution apparatus 10, first, acquires a credit score that is based on user's credit information. Next, the information distribution apparatus 10, in accordance with the acquired credit score, selects items to be input by the user and distributes a web page for accepting the input of the selected items to the user.

1-3. Example of information Distribution Process

Hereinafter, an example of the information distribution process performed by the information distribution apparatus 10 will be described with reference to FIG. 1. For example, the distribution server 200 transmits a web page C10 including contents C11 to C13 in which links to web pages (hereinafter, referred to as “application pages”) used for applying for loans of the financial institutions #A to #C are set to the user terminals 100 (step S1). Each of the users U01 and U02 reads this web page C10 by using the user terminal 100. In a case where each of the users U01 and U02 selects the content C11, the user terminal 100 transmits a request for distributing an application page of a loan of the financial institution #A to the information distribution apparatus 10 together with a device identifier (hereinafter, collectively referred to as a “cookie”) such as a cookie or the like used for identifying the user U01 or U02 (step S2)

As will be described later, after receiving the distribution request, the information distribution apparatus 10 acquires a credit score of each of the users U01 and U02 that are request sources. However, there are cases where a slight time lag occurs in the acquisition of the credit score. Thus, when a distribution request is received, first, the information distribution apparatus 10 distributes a basic information input page C20 used for accepting the input of items requested to be input for all the users regardless of credit levels among items used for an examination, in other Words, predetermined essential items to the user terminal 100 (step S3). For example, the information distribution apparatus 10 distributes a web page accepting the input of essential items such as a name, the date of birth, an address, a phone number, and the like as the basic information input page C20.

Next, while each of the users U01 and U02 inputs each item of the basic information input page C20, the information distribution apparatus 10 acquires the credit score of each of the users U01 and U02. More specifically, immediately after the distribution of the basic information input page C20, the information distribution apparatus 10 requests the credit score of each of the users U01 and U02 for the credit information providing server 300 (step S4) and acquires the credit score of each of the users U01 and U02 from the credit information providing server 300 (step S5). The information distribution apparatus 10, for example, specifies each of the users U01 and U02 by using an identifier used for identifying each of the users U01 and U02 that are transmission sources of the distribution request or a cookie used for Idenifying the user terminal 100 used by each of the users U01 and U02 and acquires the credit score of each of the specified users U01 and U02.

Here, a specific example of the process in which the information distribution apparatus 10 acquires a credit score will be described. For example, the credit information providing server 300 manages a cookie assigned to the user terminal 100 used by each user and the credit information of each user in association with each other. Then, when the value of a cookie acquired from the user terminal 100 used by each of the users U01 and U02 is received, the credit information providing server 300 specifies credit information associated with the value of the received cookie and calculates the value of the credit score based on the specified credit information. The credit information providing server 300 calculates a credit score having a larger value as the user has a higher credit level (in other words, having a higher likelihood of payment of a loan or the like) and transmits the value of the calculated credit score to the information distribution apparatus 10.

However, a method for acquiring a credit score using the information distribution apparatus 10 is not limited thereto. For example, the information distribution apparatus 10 stores the name and the date of birth of each of users U01 and U02 and the value of a cookie assigned to the user terminal 100 used by each of the users U01 and U02 in association with each other. Then, when the value of a cookie is received from the user terminal 100, the information distribution apparatus 10 may specify the name and the date of birth of a user associated with the received value of the cookie and acquire the value of a credit score from the credit information providing server 300 by using the name and the date of birth that have been specified as inquiry keys. In addition, the information distribution apparatus 10 may acquire credit information from the credit information providing server 300 and calculate the value of a credit score based on the content of the acquired credit information at each time. In other words, in a case where the content C11 in Which a link to an application page is set is selected by each of the users U01 and U02, the information distribution apparatus 10 may acquire a credit score in an arbitrary form as long as the credit score of each of the users U01 and U02 is acquired.

Subsequently, the information distribution apparatus 10, after acauiring the credit score of each of the users U01 and U02, selects items (hereinafter, may be also described as “input items”) to be input by each of the users U01 and U02 in accordance with the acquired credit score (step S6). More specifically, the information distribution apparatus 10 selects items corresponding to a number according to the value of the acquired credit score. For example, in a case where the value of the credit score is larger than a predetermined threshold, the information distribution apparatus 10 selects items corresponding to a number smaller than a predetermined number. On the other hand, in a case where the value of the credit score is smaller than the predetermined threshold, the information distribution apparatus 10 selects items corresponding to a number larger than the predetermined number.

In addition, the input items selected by the information distribution apparatus 10 are assumed to be determined in advance in accordance with the value of a credit score. For example, the information distribution apparatus 10 selects an input item “family structure” in a case where the value of the credit score is a first threshold or less and selects an input item “occupation,” in a case where the value of the credit score is a second threshold value, which is smaller than the first threshold, or less, In other words, the information distribution apparatus 10 decreases the number of input items as the value of user's credit score is larger and increases the number of input items as the value of user's credit score is smaller. In addition, items to be input by the user in accordance with a specific value of the credit score can be arbitrarily set according to conditions desired by a financial institution and the like.

Then, the information distribution apparatus 10 generates information input pages C31 and C32 used for accepting the input of the items selected in step S6. For example, in a case where the credit score of the user U01 is higher than a predetermined threshold, the information distribution apparatus 10 generates the information input page C31 accepting only the input of an item “desired loan amount”. On the other hand, for example, in a case where the credit score of the user U02 is lower than the predetermined threshold, the information distribution apparatus 10 generates the information input page C32 accepting the input of the items “other company loan amount”, “purpose of use”, “family structure” and the like in addition to the item “desired loan amount”.

In addition, for example, in a case where the input of the items of the basic information input page C20 is completed, a button “Next” is selected, in other words, in a case where the input of essential items is completed, the information distribution apparatus 10 distributes the generated information input pages C31 and C32 (step S7). For example, the information distribution apparatus 10 distributes the information input page 031 to the user U01 and distributes the information input page 032 to the user U02. As a result, the user U01 performs only the input of the item “desired loan amount”, and the user U02 performs the input of also “other company loan amount”, “purpose of use”, “family structure” and the like in addition to the item “desired loan amount”.

In addition, when the users U01 and U02 input the items of the information input pages C31 and C32 and select a button “Apply”, the user terminal 100 transmits an examination request to the information distribution apparatus 10 together with information of the input items (step S8). In this way, the information distribution apparatus 10 starts examinations of loans and the like for the users U01 and U02.

In this way, the information distribution apparatus 10 distributes an application page having less input items as the credit score of each of the users U01 and U02 is higher and distributes an application page having more input items as the credit score is lower. As a result, the information distribution apparatus 10 reduces the input operation of a user whose credit score is high, for example, like the user U01, in other words, a user of a low risk, thereby suppressing the loss of the opportunity of use. In addition, the information distribution apparatus 10 increases the number of input items for a user whose credit score is low, like the user U02, in other words, a user of a high risk, thereby improving the examination accuracy.

1-4. Credit Information

In the example described above, while it is assumed that the information distribution apparatus 10 can acquire the credit scores of the users U01 and U02 by using the identifiers of the users U01 and U02 and the cookies of the user terminal 100, in a case where the credit information of the user U01 is not registered in the credit information providing server 300, the information distribution apparatus 10 cannot acquire a credit score based on credit information. Thus, in a case where the credit score of a user cannot be acquired, the information distribution apparatus 10 selects input items determined in advance. For example, in a case where the credit score of a user cannot be acquired, the information distribution apparatus 10 may distribute the information input page C32 that includes all the items.

1-5. Type of User Terminal

Here, in a case where the user terminal 100 is an information processing apparatus such as a PC for which an input can be easily made, also in a case where the number of items is increased, the input operation is not that much troublesome for the user, and the opportunity loss is not degraded much. Thus, the information distribution apparatus 10 may select items in accordance with the type of user terminal 100. For example, the information distribution apparatus 10 may select items in accordance with the value of the credit score in a case where the user terminal 100 is a small device such as a smartphone and select all the input items in a case where the user terminal 100 is a large information processing apparatus such as a PC.

1-6. Process in Consideration of Behavior History

In addition, the information distribution apparatus 10 may further include items to be input in accordance with the behavior history of a user. For example, when a distribution request is received from the user U01, the information distribution apparatus 10 acquires a behavior history on the web that has been recently performed by the user U01 from a log server not illustrated in the drawing or the like and acquires information such as search queries input by the user U01, web pages read by the user U01, and the like. For example, in a case where the user U01 frequently searches and reads web pages relating to job offers, in addition to input items selected according to the credit score, items relating to occupation and an income may be further selected. In addition, for example, in a case where the user U01 frequently searches and reads kindergartens, blogs relating to children raising, and the like, the information distribution apparatus 10 may further include an input item relating to the family structure. Furthermore, for example, in a case where the user U01 frequently searches and reads web pages relating to payback of debts such as web pages relating to overpayment, the information distribution apparatus 10 may further include detailed input items relating to a current loan amount from the other companies and payback conditions.

1-7. Learning

Here, items to be selected as input items in accordance with the credit score or the behavior history may be arbitrarily set. For example, the information distribution apparatus 10 may employ a setting different for each financial institution performing an examination of a loan or the like. In addition, the information distribution apparatus 10 may include a model that has learned items to be selected as input items in accordance with the credit score or the behavior history.

For example, the information distribution apparatus 10 may include a model determining items to be input based on the credit score or the behavior history of a user by using indicators representing items to be input and the like from items input for each of the users U01 and U02, results of the examinations for the users U01 and U02, and results of provision of services such as a smooth payback for a loan for each of the users U01 and U02 and the like. Such a model can be realized using arbitrary machine learning technologies, for example, such as genome-wide association study (GWAS), deep learning, a support vector machine (SVM), and the like. Then, for example, in a case where a distribution request is received from a new user, the information distribution apparatus 10 may specify items to be input by inputting the credit score, the behavior history, and the like of the user to the model.

### 2. CONFIGURATION OF INFORMATION DISTRIBUTION APPARATUS

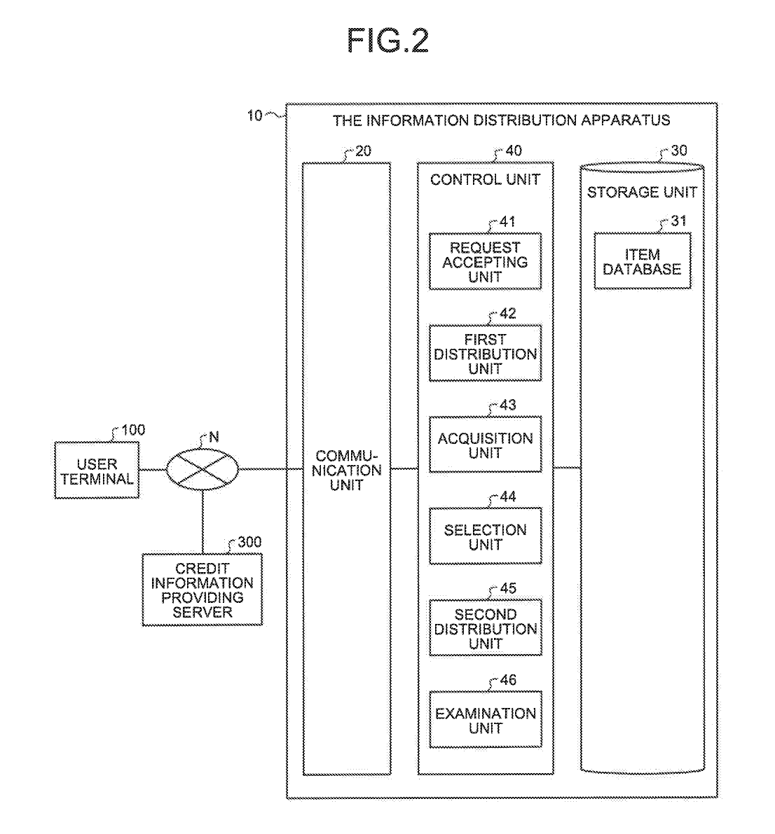

Hereinafter, an example of the functional configuration of the information distribution apparatus 10 realizing the information distribution process described above will be described. FIG. 2 is a diagram that illustrates an example of the configuration of the information distribution apparatus according to an embodiment. As illustrated in FIG. 2, the information distribution apparatus 10 includes: a communication unit 20; a storage unit 30; and a control unit 40.

The communication unit 20, for example, is realized by a network interface card (NIC) or the like. The communication unit 20 is connected to a network N in a wired or wireless manner and transmits/receives information to/from the user terminal 100 or the credit information providing server 300.

The storage unit 30, for example, is realized by a semiconductor memory device such as a random access memory (RAM) or a flash memory or a storage device such as a hard disk or an optical disc. In addition, the storage unit 30 stores an item database 31.

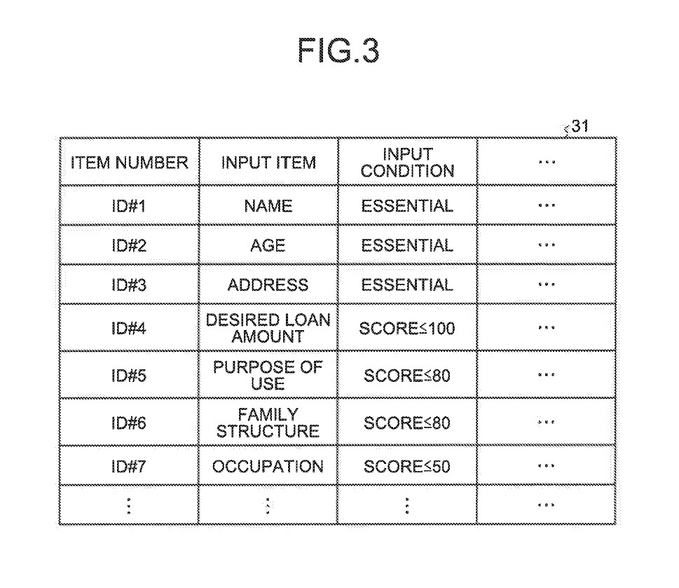

In the item database 31, various input items requested to be input by a user and information representing selection of each input item for a certain value of the credit score are registered. For example, FIG. 3 is a diagram that illustrates an example of information registered in the item database according to an embodiment. In the example illustrated in FIG. 3, in the item database 31, items such as an “item number”, an “input item”, an “input condition”, and the like are registered. In addition, various items may be registered in the item database 31 in addition to the information illustrated in FIG. 3.

Here, the “item number” is a number used for identifying each item. In addition, the “input item” is a content input by the user. Furthermore, the “input condition” is a condition representing whether or not a corresponding item is essential and the selection of a corresponding item for a certain value of the credit score.

For example, in the example illustrated in FIG. 3, an item number “ID#1” is registered. such that an input item is “name”, and an input condition is “essential”. This item represents that the information input of user's “name” is essential, and input is accepted from the user through the basic information input page C20.

In addition, in the example illustrated in FIG. 3, an item number “ID#4” is registered such that an input item is a “desired loan amount”, and an input condition is “score≦100”. This item represents that, in a case where the value of user's credit score is “100” or less, the “desired loan. amount” is selected as an input item, and input from the user is accepted through the information input pages C31 and C32. In addition, in the example illustrated in FIG. 3, in an item number “ID#5”, an input item “purpose of use” and an input condition “score≦80” are registered. Such information represents that, in a case where the value of the user's credit score is “80” or less, tie “purpose of use” is selected as an input item, and input from the user is accepted through the information input pages C31 and C32.

Referring back to FIG. 2, the description will be continued. The control unit 40 is a controller and, for example, is realized as various programs stored in an internal storage device of the information distribution apparatus 10 is executed by a processor such as a central processing unit (CPU) or a micro processing unit (MPU) using a RAN or the like as a work area. In addition, the control unit 40 may be a controller and, for example, be realized by an integrated circuit such as an application specific integrated circuit (ASIC) or a field programmable gate array (FPGA).

As illustrated in FIG. 2, the control unit 40 includes: a request accepting unit 41; a first distribution unit 42; an acquisition unit 43; a selection unit 44; a second distribution unit 45; and an examination unit 46. In addition, the first distribution unit 42 and the second distribution unit 45 may be integrated together.

The request accepting unit 41 accepts distribution request for a web page accepting an application for a service, in other words, an application page from a user. More specifically, in a case where a content Cil in which a link to an application page is set is selected by a user, the request accepting unit 41 receives a distribution request from a user terminal together with a cookie assigned to the user terminal 100 used by the user.

After the distribution request is accepted, the first distribution unit 42 distributes the basic information input page C20 accepting the input of items (essential items) of which input is essential. For example, in a case where a distribution request is received from the user terminal 100, the first distribution unit 42 selects items of which input conditions are “essential” by referring to the item database 31. Then, the first distribution unit 42 generates a basic information input page C20 accepting input of selected items and distributes the generated basic information input page C20. In addition, the first distribution unit 42 may store the basic information input page C20 in the storage unit 30 in advance and distribute the basic information input page C20 stored in advance in a case where a distribution request is accepted.

After the distribution request is accepted from the user, the acquisition unit 43 acquires a credit score based on user's credit information. For example, in a case where the content C11 in which the link to the application page is set is selected by the user, the request accepting unit 41 accepts user's identifier or a cookie acquired from the user terminal 100. Next, the acquisition unit 43 specifies a user by using the identifier or the cookie that has been accepted and acquires a credit score of the specified user. More specifically, the acquisition unit 43 notifies the credit information providing server 300 of the accepted identifier or cookie and requests transmission of a credit score that is based on the credit information of a user specified by the notified identifier or cookie. As a result, the acquisition unit 43 can acquire the credit score of the user that is a distribution request source.

The selection unit 44 selects items to be input by the user in accordance with the acquired. credit score. More specifically, the selection unit 44 selects items according to the value of the acquired credit score. For example, in a case where the value of the credit score is larger than a predetermined threshold, items less than a predetermined number are selected. On the other hand, in a case where the value of the score is smaller than the predetermined threshold, items corresponding to the predetermined number or more are selected.

Here, an example of the process performed by the selection unit 44 will he described. In the description presented below, information as illustrated in FIG. 3 is assumed to be registered in the item database 31. First, the selection unit 44 searches for items of which contents registered as input conditions coincide with the value of the acquired credit score from the item database 31. For example, in a case where the value of the acquired credit score is “100”, the item “desired loan amount” of which the input condition is “score≦100” is selected. In addition, for example, in a case where the value of the acquired credit score is “70”, three items including the item “desired loan amount” of which the input condition is “score≦100” and the item “purpose of use” and the item “family structure” of which the input conditions are “score≦80” are selected.

In addition, in a case where the acquisition of the credit score fails, the selection unit 44 may select predetermined items set in advance. For example, in a case where the acquisition of the credit score fails, the selection unit 44 may select items by assuming the value of the credit score to be a predetermined value (for example, an average value). In addition, all the items registered in the item database 31 may be selected.

In addition, the selection unit 44 may select items to be input by the user in accordance with the credit score and the type of the user terminal 100 used when the user reads an application page. For example, in a case where the type of user terminal 100 is a smart device, the selection unit 44 may select items in accordance with the credit score and, in a case where the type of user terminal 100 is a PC, the selection unit 44 may select items by assuming the value of the credit score to be a predetermined value (for example, an average value) or select all the items registered in the item database 31.

Furthermore, the selection unit 44 may further add items of information in accordance with user's behavior history. For example, the selection unit 44, first, selects input items based on the value of the credit score, in addition, the selection unit 44 acauires contents of user's web searches and the like from a log server not illustrated in the drawing or the like and further adds input items in accordance with a search history that is the history of search queries input by the user, the history of reading web pages, and the like. The selection unit 44 may arbitrary adds items, which are desired to be input by the user from a financial institution, relating to provision of a loan or the like or payback based on the user's search history, the user's history of reading web pages, or the like.

A financial institution or the like performs an examination of the user by comprehensively using the information of the input items selected in this way. For example, in an examination of a loan or the like, the item “occupation” is frequently selected as an essential item. However, in a case where a user searches for part-time jobs at recruiting sites or the like while the user has input the item “occupation”, there is a possibility that the user actually does not have a job. In such a case, considering a possibility that the user tells a lie, a financial institution may request the user to further input detailed items relating to the occupation. In other words, in a case where there is discordance between user information that is estimated from the behavior history such as the history of reading web pages and the search history, and the like of the user and a content input by the user, a financial institution may ask a more detailed question to the user in the examination. Then, the financial institution comprehensively performs an examination by combining the user's input contents and the information estimated based on the read history and the search history.

In order to realize such a process, the selection unit 44 may perform selection of input items in accordance with information input by the user through the basic information input page and the behavior history of the user More specifically, the selection unit 44 may determine whether or not the content of essential items input by the user and the user information estimated based on the behavior history of the user coincide with each other and, in the case of no-coincidence, select more detailed items as input items. In addition, the selection unit 44 may determine whether nor not the content of items accepted from the user through the information input pages C31 and C32 and the user information estimated based on the user's behavior history coincide with each other in addition to the content of the essential items and, in the case of no-coincidence, re-select more detailed items as input items and re-distribute an information input page including the re-selected input items.

The second distribution unit 45 accepts input items selected by the selection unit 44 based on the credit score, the behavior history, and the like and generates information input pages C31 and C32. Then, after all the essential items of the basic information input page C20 are input by the user, the second distribution unit 45 distributes the generated information input pages C31 and C32 to the user.

The examination unit 46 performs an examination, of a loan or the like for the user. For example, when the user inputs all the items of the information input pages C31 and C32 and selects an “application” button, the examination unit 46 determines whether or not a service of a loan or the like is provided for the user based on the content of the items input to the basic information input page C20 and the information input pages C31 and C32. In addition, the process performed by the examination unit 46 may be a provisional examination before a main examination. Furthermore, the process performed by the examination unit 46 may be manually realized. In addition, a result of the examination performed by the examination unit 46 may be employed as a result of the main examination only in a case where the result is authenticated by a predetermined person who belongs to the financial institution.

### 3. EXAMPLE OF ITEMS TO BE SELECTED

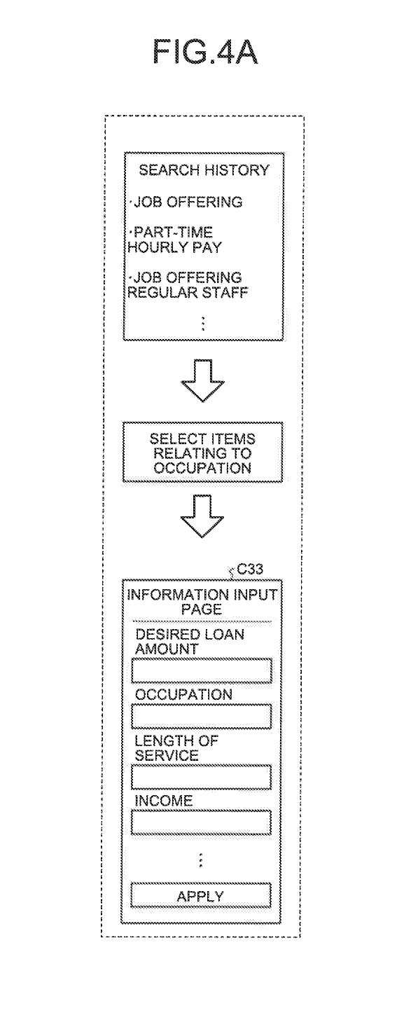

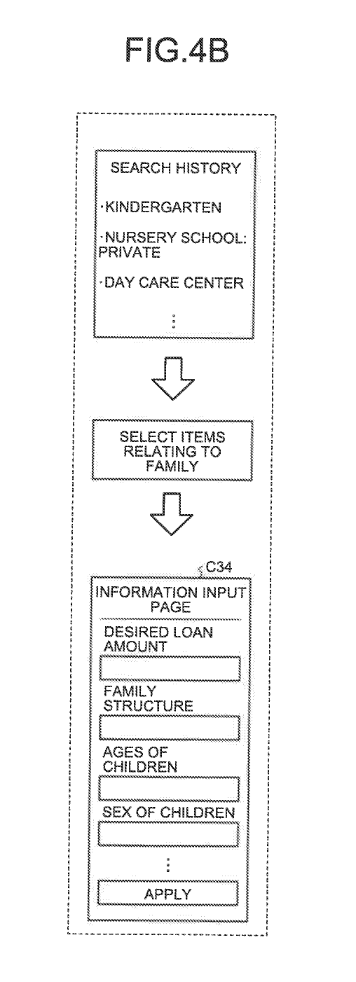

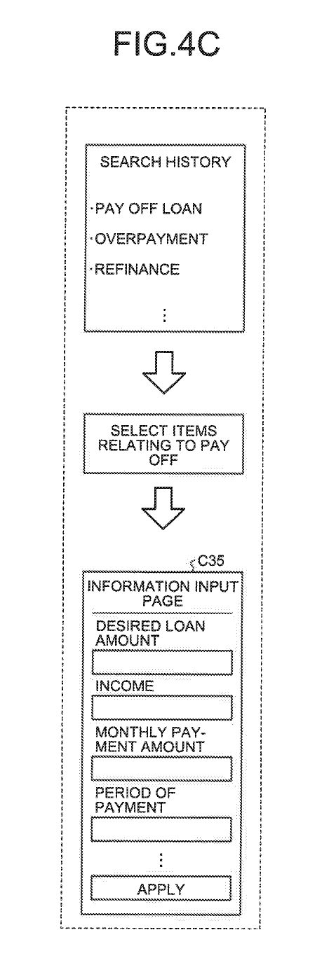

Next, an example of items selected by the information distribution apparatus 10 will be described with reference to FIGS. 4A to 4C. FIGS. 4A to 4C are diagrams that illustrate an example of items selected by the information distribution apparatus according to an embodiment. In FIGS. 4A to 4C, a specific example of the process of selecting input items based on the user's behavior history is illustrated.

The information distribution apparatus 10 selects the item “desired loan amount” as an input item based on user's credit score. In addition, the information distribution apparatus 10 acquires a search history from the log server or the like. Then, the information distribution apparatus 10, based on the search history, adds items desired to be input by user from the financial institution as input items.

For example, as illustrated in. FIG. 4A, in a case where there are “job offers”, “part-time hourly pay”, “job offer: regular staff” and the like relating to recruiting in the search history, items relating to the occupation. such as “occupation”, “length of service”, and “income” are added. Then, the information distribution apparatus 10 distributes an information input page C33 accepting input of the items “occupation”, “length of service” and “income”, and the like selected based on the search history together with the item “desired loan amount” selected based on the credit score.

In addition, for example, as illustrated in FIG. 4B, in a case where there are “kindergarten”, “nursery school private”, “day care center”, and the like relating to raising children in the search history, family-related items such as “family structure”, “ages of children”, and “sex of children” are added. Then, the information distribution apparatus 10 distributes an information input page C34 accepting input of the items “family structure”, “ages of children”, “sex of children”, and the like selected based on the search history together with the item “desired loan amount” selected based on the credit score.

In addition, for example, as illustrated in FIG. 4C, in a case where there are “pay off the loan”, “overpayment”, “refinance”, and the like relating to the pay off a loan in the search history, pay-off related items such as “income”, “monthly payment amount”, “period of payment”, and the like are added. Then, the information distribution apparatus 10 distributes an information input page C35 accepting the input of the items “income”, “monthly payment amount”, “period of payment”, and the like selected based on the search history together with the item “desired loan amount” selected based on the credit score.

### 4. EXAMPLE OF FLOW OF INFORMATION DISTRIBUTION PROCESS

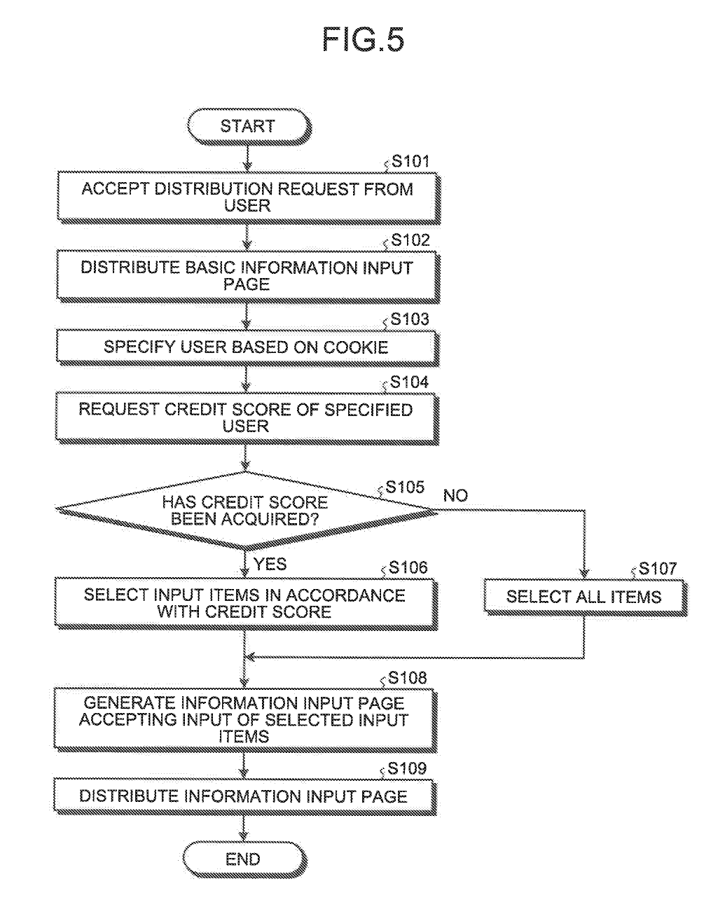

Subsequently, the flow of the information distribution process performed by the information distribution apparatus 10 will be described with reference to FIG. 5. FIG. 5 is a flowchart that illustrates an example of the flow of the information distribution process performed by the information distribution apparatus according to an embodiment. First, the information distribution apparatus 10 accepts a distribution request of an application page from a user (step S101). The information distribution apparatus 10 distributes the basic information input page C20 (step S102). Subsequently, the information distribution apparatus 10 specifies a user based on the identifier or the cookie of the user (step S103) and requests a credit score of the specified user for the credit information providing server 300 (step S104).

Next, the information distribution apparatus 10 determines whether or not the credit score can be acquired (step S105) and, in a case where the credit score can be acquired (step S105: Yes), selects input items in accordance with the credit score (step S106). On the other hand, in a case where the credit score cannot be acquired (step S105: No), the information distribution apparatus 10 selects items set in advance or all the items as input items (step S107). Then, the information distribution apparatus 10 generates information input pages C31 to C35 accepting the input of selected input items (step S108), distributes the generated information input pages C31 to C35 to users (step S109), and ends the process.

### 5. MODIFIED EXAMPLE

In the description presented above, an example of the information distribution process performed by the information distribution apparatus 10 has been described. However, the embodiment is not limited thereto. Hereinafter, variations in the information distribution process performed by the information distribution apparatus 10 will be described.

5-1. Apparatus Configuration

The information distribution apparatus 10 may be connected to an arbitrary number of user terminals 100 to be communicable therewith. In addition, the information distribution apparatus 10 may be realized by a front end server exchanging information with the user terminal 100 and a back end. server selecting input items. In such a case, the request accepting unit 41, the first distribution unit, the second distribution unit 45, and the examination unit 46 illustrated in FIG. 2 are arranged in the front end server, and the acquisition unit 43, the selection unit 44, and the like are arranged in the back end server.

5-2. Transmission Form

In the example described above, the information distribution apparatus 10, at a timing at which the requests for application pages are accepted from the users U01 and U02, in other words, at timing at which the content C11 is selected by the users U01 and U02, acquires the credit scores of the users U01 and U02 together with distributing the basic information input page C20. However, the embodiment is not limited thereto. For example, the information distribution apparatus 10, immediately after accepting request for application pages from the users U01 and U02, acquires the credit scores of the users U01 and U02 and selects input items based on the values of the acquired credit scores. Then, the information distribution apparatus 10 may generate a web page accepting both the essential items and the selected input items and distribute the generated web page. In other words, the information distribution apparatus 10 may distribute a web page integrating the basic information input page C20 and the information input pages C31 to C35.

5-3. information Input Page

In the example described above, the information distribution apparatus 10 performs selection of items according to the credit score. However, the embodiment is not limited thereto. For example, the information distribution apparatus 10 may generate the information input pages C31 and C32 in advance and share the information input pages C31 and C32 in accordance with the value of the credit score. In addition, the. information distribution apparatus 10, for example, may share three or more information input pages in accordance with the value of the credit score.

In addition, in a case where the value of the credit score is larger than a predetermined threshold, the information distribution apparatus 10 may perform an examination by using only the essential items accepted by the basic information input page C20 without distributing the information input page C31. Furthermore, in a case where the value of the credit score is extremely low like in the case of a user included in a black list or the like, the information distribution apparatus 10 may perform a process of causing the user to give up an application of a loan or the like in the middle of the process by adding an item that is not normally selected as an input item.

5-4. Items

In addition, the various items used in the description presented above are merely examples, and arbitrary items may be employed as long as the items are required to be input in an application of a loan or the like.

5-5. Application Field

In the example described above, the information distribution apparatus 10 performs selection of items based on the credit score in the distribution of the basic information input page C20 and the information input pages C31 to C35 that are application pages accepting an examination of a loan or the like. However, the embodiment is not limited thereto. For example, also in a case other than the examination of a loan or the like, in order to measure a credit level of a user, the information distribution apparatus 10 may add items based on the credit score by using the information distribution process described above. For example, the information distribution apparatus 10 may arbitrarily add characteristic items in each field that are capable of appropriately measuring the credit level of the user although the input thereof is troublesome. For example, the information distribution apparatus 10 may apply the information distribution. process described above to applications for credit cards or cash cards, applications for rental houses, applications for rent-a-car, and the like. In addition, the information distribution apparatus 10 may arbitrarily set the content of items requested to be input for a user in accordance with the field that is an application target.

5-6. Addition of Items

In the example described above, the information distribution apparatus 10 selects input items based on the credit score and the behavior history of the user U01 or the behavior history of the user U01 and the information input by the user U01. However, the embodiment is not limited thereto. For example, the information distribution apparatus 10 may select input items by comprehensively determining the credit information, the credit score, the behavior history, and the information input by the user U01. For example, by analyzing the credit information, the behavior history, the information input by the user U01, and the like, the information distribution apparatus 10 specifies a determination indicator predicted to decrease the value of the credit score. Here, the determination indicator is an indicator used when the credit score is calculated and is any kind of indicator included in the credit information. Then, the information distribution apparatus 10 may select an item relating to the specified determination indicator as an input item and request the input thereof for the user U01. In this way, the information distribution apparatus 10 specifies the determination. indicator considered to decrease the credit score of the user U01, in other words, a fault in the credit of the user U01 and selects an item relating to the specified fault as an input item, and accordingly, the accuracy of the examination can be improved.

5-7. Others

In addition, all or a part of the process described to be automatically performed among the processes described in the embodiment described above may be manually performed. To the contrary, the whole or a part of the process described to be manually performed may be automatically performed using a known method. Other than that, the processing sequences, the specific names, various kinds of data, and information including parameters illustrated in the description or the drawings presented above may be arbitrarily changed unless otherwise mentioned. For example, various kinds of information illustrated in each drawing are not limited to the illustrated information.

In addition, each constituent element of each apparatus that is illustrated in the drawing is a functional and conceptual element but does not necessarily need. to be physically configured as is illustrated. In other words, a specific form of distribution/integration of each apparatus is not limited to that illustrated in the drawing, but the whole or a part thereof may be configured to be functionally or physically distributed or integrated in an arbitrary unit in accordance with various loads, the use status, and the like. For example, the first distribution unit 42 and the second distribution unit 45 illustrated in FIG. 2 may be integrated together.

Furthermore, the embodiment described above may be appropriately combined in a range causing no contradiction of the processing contents.

### 6. PROGRAM

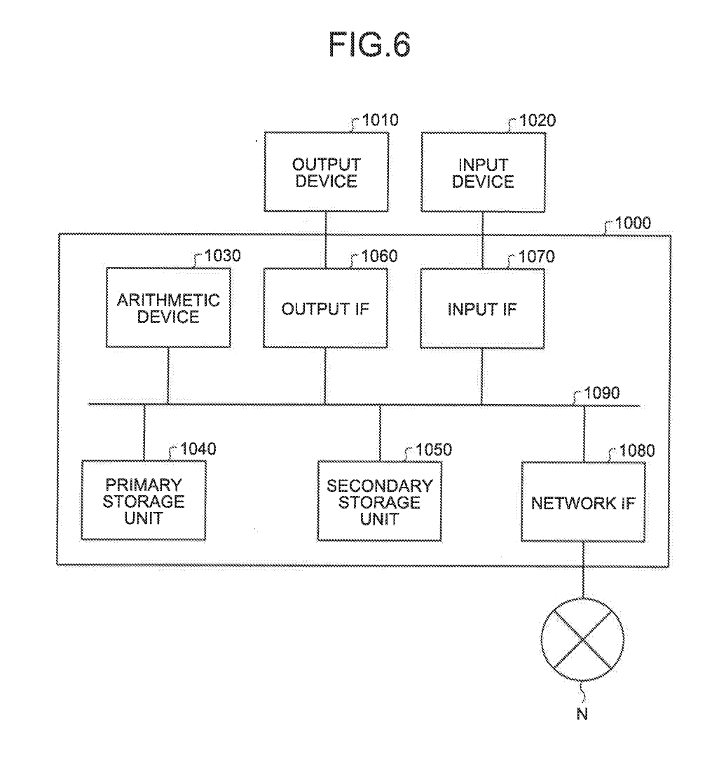

In addition, the information distribution apparatus 10 according to the embodiment described above, for example, is realized by a computer 1000 having a configuration, as illustrated in FIG. 6. FTG. 6 is a diagram that illustrates an example of the hardware configuration. The computer 1000 is connected to an output device 1010 and an input device 1020 and has a form in which an arithmetic device 1030, a primary storage device 1040, a secondary storage device 1050, an output interface (IF) 1060, an input IF 1070, and a network IF 1080 are interconnected through a bus 1090.

The arithmetic device 1030 operates based on a program stored in the primary storage device 1040 or the secondary storage device 1050, a program read from. the input device 1020, or the like, thereby performing various processes. The primary storage device 1040 is a memory device such as a RAM that primarily stores data used by the arithmetic device 1030 for various operations. In addition, the secondary storage device 1050 is a storage device in which data used by the arithmetic device 1030 for various operations and various databases are stored and s s realized by a read only memory (ROM), an HDD, a flash memory, or the like.

The output IF 1060 is an interface used for transmitting information that is an output target to the output device 1010 outputting various kinds of information such as a monitor or a printer and, for example, is realized by a connector-of a specification of a universal serial bus (USE), a digital visual interface (DVI), or a high definition multimedia interface (DMI; registered trademark). The input IF 1070 is an interface used for receiving information from various input devices 1020 such as a mouse, a keyboard, a scanner, and the like and, for example, is realized by the USE or the like.

In addition, the input device 1020, for example, may be a device reading information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like. Furthermore, the input device 1020 may be an externally-attached storage medium such as a USE memory.

The network IF 1080 receives data from other devices through a network N and transmits the received data to the arithmetic device 1030 and transmits data. generated by the arithmetic device 1030 to other devices through the network N.

The arithmetic device 1030 controls the output device 1010 and the input device 1020 through the output IF 1060 and the input IF 1070. For example, the arithmetic device 1030 loads a program from the input device 1020 or the secondary storage device 1050 into the primary storage device 1040 and executes the loaded program.

For example, in a case where the computer 1000 functions as the information distribution apparatus 10, the arithmetic device 1030 of the computer 1000 executes a program loaded into the primary storage device 1040, thereby realizing the function of the control unit 40

### 7. EFFECTS

As described above, the information distribution apparatus 10, after accepting a distribution request of an application page from the user U01, acquires a credit score that is based on the credit information of the user U01. Next, the information distribution apparatus 10 selects items to be input by the user U01 in accordance with the acquired credit score. Then, the information distribution apparatus 10 distributes the information input pages C31 to C35 accepting the input of selected items to the user U01. In this way, the information distribution apparatus 10 can optimize an input operation of information accompanying an application of a service such as a loan or the like for each user while preventing the degradation of the accuracy of the examination of the user. As a result, the information distribution apparatus 10 can prevent an opportunity loss of a user having a high credit score giving up the input of the page and prevent degradation of the accuracy of the examination of a user having a low credit score.

In addition, the information distribution apparatus 10 specifies a user U01 by using the identifier of the user U01 or the cookie acquired from the user terminal 101 used by the user U01. In addition, by acquiring the credit score of the specified user U01 before the user U01 selects the content C11 in which a link (for example, the basic information input page C20) to an application page is set, the information distribution apparatus 10 can acquire the credit score of the user U01 before the user U01 inputs the basic information such as the name and the like.

Furthermore, the information distribution apparatus 10, after accepting a distribution request of an application page, first, distributes the basic information input page C20 accepting the input of the essential items to the user U01. Next, after accepting the input of the essential items, the information distribution apparatus 10 distributes the other information input pages C31 to C35 accepting the input of selected items to the user U01. In this case, since the information distribution apparatus 10 performs acquisition of the credit score or selection of input items while the user U01 inputs the basic information input page C20, the information distribution apparatus 10 can select items based on the credit score while resolving a time lag until the application page is displayed after the selection of the content C11.

In addition, the information distribution apparatus 10 selects items corresponding to a number according to the acquired credit score. For example, in a case where the value of the credit score is larger than a predetermined threshold, the information distribution apparatus 10 selects items corresponding to a number smaller than a predetermined number. On the other hand, in a case where the value of the credit score is smaller than the predetermined threshold, the information distribution apparatus 10 selects items corresponding to the predetermined number or more. For this reason, the information distribution apparatus 10 can optimize an input operation of information accompanying an application of a service such as a loan or the like for each user while preventing the degradation of the accuracy of the examination of the user.

In addition, in a case where the acquisition of the credit score fails, the information distribution apparatus 10 selects predetermined items set in advance. For this reason, the information distribution apparatus 10 can prevent the degradation of the accuracy of the examination of a user whose credit score is not registered or the like.

In addition, the information distribution apparatus 10 selects items to be input by the user U01 in accordance with the credit score and the type of user terminal 100 used when the user U01 reads the information input pages C31 to C35. For example, only in a case where the user U01 uses a smart device, the information distribution apparatus 10 performs selection of input items according to the credit score and, in the case of a PC user, selects items set in advance regardless of the value of the credit score. In this way, since the information distribution apparatus 10 can distribute an application page in consideration of the environment in which the user UO1 inputs each item, an input operation of the information accompanying an application of a service such as a loan or the like can be optimized for each user while preventing the degradation of the accuracy of the examination.

Furthermore, the information distribution apparatus 10 further selects items to be input by the user U01 in accordance with the behavior history of the user U01 and distributes the information input pages C31 to C35 accepting the input of the items selected according to the credit score and the items selected according to the behavior history to the user U01. For this reason, since the information distribution apparatus 10 can request the user to input the items according to the behavior of the user U01, the accuracy of the examination can be further improved.

In addition, the information distribution apparatus 10 further selects items of information to be input by the user U01 based on the behavior history of the user U01 and the content of the information input by the user U01. Then, the information distribution apparatus 10 causes the user U01 to input the selected information. For this reason, for example, in a case where the user U01 is predicted to perform false input or the like, the information distribution apparatus 10 can cause more detailed items to be input, and accordingly, the accuracy of the examination can be further improved.

The “sections, modules, or units” described above may be paraphrased by “means” or “circuits”. For example, the distribution unit may be paraphrased by a distribution means or a distribution circuit.

According to one aspect of an embodiment, an input operation of information accompanying an application for a service can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein Set forth.

The above-described embodiment can be applied not only to an information distribution apparatus, an information distribution method, and an information distribution program but also to an information distribution apparatus for switching a structure of data for digital screen display. The information distribution apparatus for switching a structure of data for digital screen display, the information distribution apparatus includes an acquisition unit (corresponding to acquisition unit 43) that, through a digital communications network from a client communications network from a client information terminal device, in a case where a distribution request of data for digital screen display to accept an application by receiving a data transmission based on an input operation accepted is accepted in correspondence with a data item on a digital screen displayed by rendering in the client information terminal device, acquires a predetermined score stored in a storage device for a user corresponding to the client information terminal device. The information distribution apparatus for switching a structure of data for digital screen display, the information distribution apparatus includes a selection unit (corresponding to selection unit 44) that selects a data item to be incorporated as a component into the data for digital screen display to be distributed to the client information terminal device in accordance with. the score acquired by the acquisition unit. The information distribution apparatus for switching a structure of data for digital screen display, the information distribution apparatus includes a distribution unit (corresponding to second distribution unit 45) that, after incorporating a component corresponding to the data selected by the selection unit into the data for digital screen display, distributes the resultant data for digital screen display to the client information terminal device that is a transmission source of the distribution request.

The information distribution apparatus for switching a structure of data for digital screen display can be applied not only to a credit score but also to other scores such as a score of technological level. The information distribution apparatus for switching a structure of data for digital screen display can be applied not only to an application of a service but also to other applications such as an application of lodgment of a complaint. The information distribution apparatus for switching a structure of data for digital screen display can be applied not only to a web page but also to other screens such as a digital screen based on other specifications. “An information distribution apparatus comprising: in a case where a distribution request of a web page accepting an application of a service is accepted from a user, an acquisition unit that acquires a credit score based on credit information of the user; a selection unit that selects items to be input by the user in accordance with the credit score acquired by the acquisition unit; and a distribution unit that distributes a web page accepting input of the items selected by the selection unit to the user” can be performed alone without requiring a configuration “an information distribution apparatus for switching a structure of data for digital screen display, the information distribution apparatus comprising: an acquisition unit that, through a digital communications network from a client communications network from a client information terminal device, in a case where a distribution request of data for digital screen display to accept an application by receiving a data transmission based on an input operation accepted is accepted in correspondence with a data item on a digital screen displayed by rendering in the client information terminal device, acquires a predetermined score stored in a storage device for a user corresponding to the client information terminal device; a selection unit that selects a data item to be incorporated as a component into the data for digital screen display to be distributed to the client information terminal device in accordance with the score acquired by the acauisition unit; and a distribution unit that, after incorporating a component corresponding to the data selected by the selection unit into the data for digital screen display, distributes the resultant data for digital screen display to the client information terminal device that is a transmission source of the distribution request”.

What is claimed is:

1. An information distribution apparatus for switching a structure of data for digital screen display, the information distribution apparatus comprising:
an acquisition unit that, through a digital communications network from a client communications network from a client information terminal device, in a case where a distribution request of data for digital screen display to accept an application by receiving a data transmission based on an input operation accepted is accepted in correspondence with a data item on a digital screen displayed by rendering in the client information terminal device, acquires a predetermined score stored in a storage device for a user corresponding to the client, information terminal device;
a selection unit that selects a data item to be incorporated as a component into the data for digital screen display to be distributed to the client information terminal device in accordance with the score acquired by the acquisition unit; and
a distribution unit that, after incorporating a component corresponding to the data selected by the selection unit into the data for digital screen display, distributes the resultant data for digital screen display to the client information terminal device that is a transmission source of the distribution request.

2. The information distribution apparatus according to claim 1, wherein
in a case where a distribution request of a web page accepting an application of a service is accepted from a user, the acquisition unit acquires a credit score based on credit information of the user;
the selection unit selects items to be input by the user in accordance with the credit score acquired by the acquisition unit; and
the distribution unit distributes a web page accepting input of the items selected. by the selection unit to the user.

3. The information distribution apparatus according to claim 2, wherein the acquisition unit specifies the user by using an. identifier of the user or a cookie acquired from a terminal device used by the user and acquires the credit score of the specified user.

4. The information distribution apparatus according to claim 2, wherein the acquisition unit, in a case where a content in which a link to the web page is set is selected by the user, acquires the credit score of the user.

5. The information distribution apparatus according to claim 2, wherein the distribution unit, in a case where a distribution request of the web page is accepted, distributes a first web page accepting input of essential items to the user and, in a case where the input of the essential items is accepted, distributes a second web page accepting input of the items selected by the selection unit to the user.

6. The information distribution apparatus according to claim 2, wherein the selection unit selects a specified number of items according to the credit score acquired by the acquisition unit.

7. The information distribution apparatus according to claim 6, wherein the selection unit selects items corresponding to a number less than a predetermined number in a case where a value of the credit score is larger than a predetermined threshold and selects items corresponding to the predetermined number or more in a case where the value of the credit score is less than the predetermined threshold.

8. The information distribution apparatus according to claim 2, wherein the selection unit, in a case where the acquisition unit falls to acquire the credit score, selects predetermined number of items set in advance.

9. The information distribution apparatus according to claim 2, wherein the selection unit selects items to be input by the user in accordance with the credit score and a type of the terminal device used when the user reads the web page.

10. The information distribution apparatus according to claim 2,
wherein the selection unit further selects an item to be input by the user in accordance with a behavior history of the user, and wherein the distribution unit distributes a web page accepting input of the items selected by the selection unit in accordance with the credit score and the item selected according to the behavior history to the user.

11. The information distribution apparatus according to claim 10, wherein the selection unit further selects an item of information to be input by the user based on the behavior history of the user and a content of information input by the user.

12. A method performed by an information distribution apparatus, the method comprising:
acquiring a credit score based on credit information of a user in a case where a distribution reauest of a web page accepting an application of a service is accepted from the user;
selecting items to be input by the user in accordance with the credit score acquired in the acquiring of a credit score; and
distributing a web page accepting input of the items selected in the selecting of items to the user.

13. A non-transitory computer readable storage medium having stored therein a program causing a computer to execute a process comprising:
acquiring a credit score based on credit information of a user in a case where a. distribution request of a web page accepting an application of a service is accepted from the user;
selecting items to be input by the user in accordance with the credit score acquired in the acquiring of a credit score; and
distributing a web page accepting input of the items selected in the selecting of items to the user.
